(19) United States
(12) Patent Application Publication
(10) Pub. No.: US 2026/0288643 A1
(43) Pub. Date: Sep. 24, 2026

(54) MEMORY CONTROLLER, MEMORY SYSTEM, AND CONTROL METHOD OF MEMORY CONTROLLER

(71) Applicant: Kioxia Corporation, Tokyo (JP)

(72) Inventor: Sohichiroh HOSODA, Kawasaki (JP)

(73) Assignee: Kioxia Corporation, Tokyo (JP)

(21) Appl. No.: 19/240,379

(22) Filed: Jun. 17, 2025

(30) Foreign Application Priority Data
Mar. 24, 2025 (JP) 2025-048749

(51) Int. Cl. G06F 12/0862; G06F 12/02; G06F 13/16; G06F 13/42

(52) U.S. Cl. CPC G06F 12/0862; G06F 12/0246; G06F 13/1663; G06F 13/4234

(57) ABSTRACT

According to one embodiment, a memory controller includes: a controller circuit configured to detect one or more streams including a plurality of windows of data to be transferred to a host device, the controller circuit being configured to control prefetching of the data; and a cache memory configured to store prefetched data, wherein the controller circuit is configured to detect the streams on a basis of a data size of each of one or more first windows among the plurality of windows and a successive number of the first windows in a first period.

### CROSS-REFERENCE TO RELATED APPLICATIONS

This application is based upon and claims the benefit of priority from prior Japanese Patent Application No. 2025-048749, filed Mar. 24, 2025, the entire contents of which are incorporated herein by reference.

### FIELD

Embodiments described herein relate generally to a memory controller, a memory system, and a control method of a memory controller.

### BACKGROUND

The development of a memory system that transfers data using a compute express link (CXL) is being promoted. A data transfer may use a cache memory. It is expected that storing prefetched data in a cache memory will improve a performance of data transfer. There is a demand for a technique of suitably controlling prefetched data stored in a cache memory.

### BRIEF DESCRIPTION OF THE DRAWINGS

FIG. 1 is a block diagram showing an example of a configuration of a system including a memory controller according to a first embodiment.

FIG. 2 is a schematic diagram showing an example of a configuration of a non-volatile memory.

FIG. 3 is a block diagram showing an example of a configuration of the memory controller according to the first embodiment.

FIG. 4 is a schematic diagram for illustrating a stream.

FIG. 5 is a block diagram showing an example of a functional configuration of the memory controller according to the first embodiment.

FIG. 6 is a flowchart showing an example of an operation of the memory controller according to the first embodiment.

FIG. 7 is a flowchart showing other example of the operation of the memory controller according to the first embodiment.

FIG. 8 is a flowchart showing other example of the operation of the memory controller according to the first embodiment.

FIG. 9 is a flowchart showing another example of the operation of the memory controller according to the first embodiment.

FIG. 10 is a block diagram showing an example of a functional configuration of a memory controller according to a second embodiment.

FIG. 11 is a schematic diagram for illustrating a simultaneous stream.

FIG. 12 is a flowchart showing an example of an operation of the memory controller according to the second embodiment.

FIG. 13 is a block diagram showing an example of a functional configuration of a memory controller according to a third embodiment.

FIG. 14 is a flowchart showing an example of an operation of the memory controller according to the third embodiment.

### DETAILED DESCRIPTION

In general, according to one embodiment, a memory controller includes: a controller circuit configured to detect one or more streams including a plurality of windows of data to be transferred to a host device, the controller circuit being configured to control prefetching of the data; and a cache memory configured to store prefetched data, wherein the controller circuit is configured to detect the streams on a basis of a data size of each of one or more first windows among the plurality of windows and a successive number of the first windows in a first period.

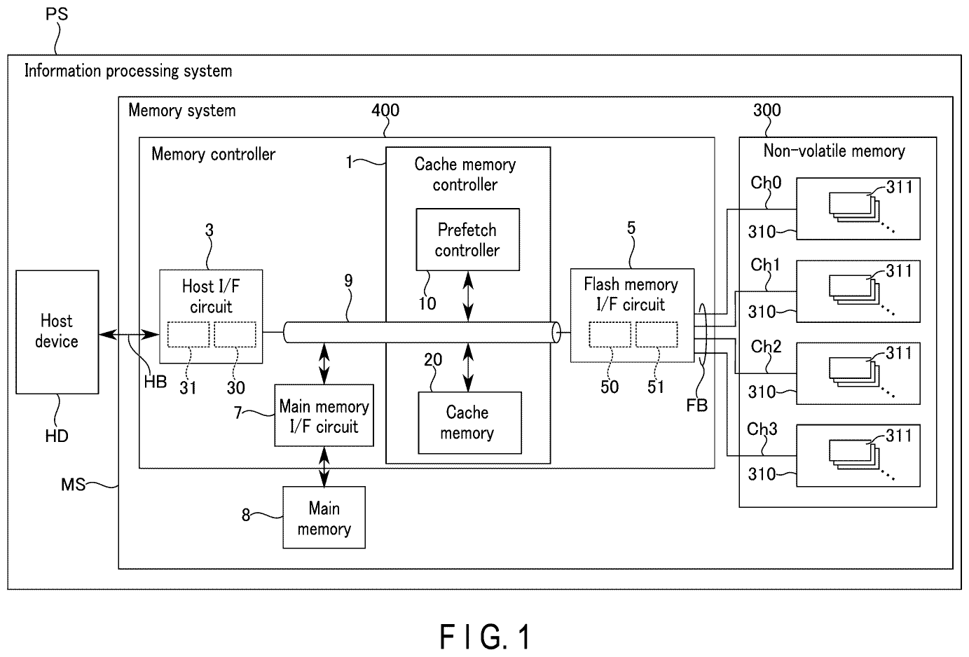

A memory controller, a memory system, and a control method of the memory controller according to an embodiment will be described with reference to FIG. 1 to FIG. 14. In the following description, components having the same functions and structures will be referred to by the same reference numerals. Furthermore, in each embodiment to be described below, structural components (e.g., circuits, interconnects, various voltages and signals, etc.) may be given a reference sign accompanied by a numeral or alphabetical character at its end. If these components do not need to be distinguished from each other, a description (reference sign) without the trailing numeral or character will be adopted.

### Embodiments

### (1) First Embodiment

A memory controller, a memory system, and a control method of a controller according to a first embodiment will be described with reference to FIG. 1 to FIG. 9.

### (a) Example of Configuration

An example of a configuration of the memory controller according to a present embodiment will be described with reference to FIG. 1 to FIG. 5.

### (a-1) Information Processing System

An example of a configuration of an information processing system including the memory controller according to the present embodiment will be described with reference to FIG. 1. FIG. 1 is a block diagram showing an example of a configuration of the information processing system including the memory controller according to the present embodiment.

As shown in FIG. 1, an information processing system PS includes a host device HD and a memory system MS.

The host device HD is an information processing device (computing device) configured to access the memory system MS. The host device HD controls the memory system MS. The host device HD requests (orders) the memory system MS to write data or read data. The host device HD transmits a write request or a read request to the memory system MS. The write request includes a command, an address, and user data. The read request includes a command and an address.

The memory system MS is a storage device including a non-volatile memory 300. The memory system MS is coupled to the host device HD via a host bus HB. The memory system MS may be coupled to the host device HD via a wireless communication network. One memory system MS may be coupled to a plurality of host devices HD. A plurality of memory systems MS may be coupled to one host device HD.

In the present embodiment, a Compute Express Link (CXL)™ specification is applied to a specification for interconnecting the memory system MS and the host device HD. The host device HD and the memory system MS interconnected by the CXL specification can share a memory space. The memory system MS coupled to the host device HD by the CXL specification is also called a CXL device. A specification (standard) for coupling the memory system MS and the host device HD is not limited to the CXL. For example, Peripheral Component Interconnect-Express (PCIe)™ may be applied.

### (A-2) Memory System

An example of a configuration of the memory system MS will be described with reference to FIG. 1.

As shown in FIG. 1, the memory system MS includes a main memory 8, the non-volatile memory 300, and a memory controller 400.

The main memory 8 is a volatile memory configured to temporarily store data. The main memory 8 is coupled to the memory controller 400. The main memory 8 temporarily stores data from the host device HD and data from the non-volatile memory 300. Data read from the main memory 8 is provided to the host device HD or the non-volatile memory 300. The main memory 8 is, for example, a dynamic random access memory (DRAM). The main memory 8 may be provided in the memory controller 400.

The non-volatile memory 300 is a memory device capable of storing data in a substantially non-volatile manner. The non-volatile memory 300 is, for example, a NAND flash memory. Hereinafter, the NAND flash memory will also be simply referred to as a flash memory.

The non-volatile memory 300 is coupled to the memory controller 400 via a flash memory bus FB that includes a plurality of channels Ch (Ch0, Ch1, Ch2, and Ch3).

The non-volatile memory 300 includes a plurality of memory modules 310. Each of the plurality of memory modules 310 is associated with a corresponding one of the plurality of channels Ch0, Ch1, Ch2, and Ch3. The plurality of memory modules 310 can communicate with the memory controller 400 independently of each other via corresponding channels Ch, respectively. The number of channels Ch of the non-volatile memory 300 is freely selected. The number of memory modules 310 of the non-volatile memory 300 depends on the number of channels Ch.

Each of the memory modules 310 includes a plurality of memory dies (memory chips) 311. The plurality of memory dies 311 are operable independently of each other. Each of the memory dies 311 receives data (hereinafter also referred to as “write data”) to be written to the memory die 311 from the memory controller 400 via a corresponding channel Ch. Each of the memory dies 311 transmits data (hereinafter also referred to as “read data”) read from the memory die 311 to the memory controller 400 via a corresponding channel Ch. The number of memory dies 311 in the memory module 310 is freely selected.

The memory controller 400 performs various types of processing of the memory system MS. The memory controller 400 includes a cache memory controller 1, a host interface circuit 3, a flash memory interface circuit 5, and a main memory interface circuit 7. The memory controller 400 is an electronic circuit including these components, and is configured as, for example, a system-on-chip (SoC).

The cache memory controller 1 controls an operation of a cache memory 20. The cache memory controller 1 is coupled to an internal bus 9. The cache memory controller 1 is coupled to the host interface circuit 3 and the flash memory interface circuit 5 via the internal bus 9. The cache memory controller 1 includes, for example, an electronic circuit. For example, the cache memory controller 1 operates under control based on given software (firmware, a program, or an application). The cache memory controller 1 includes a prefetch controller 10 and the cache memory 20. Hereinafter, the cache memory controller 1 will be referred to as a “CM controller 1”.

The prefetch controller 10 controls prefetching (caching) of read data from the non-volatile memory 300. The prefetch controller 10 may also control prefetching of data from the host device HD and data from the main memory 8. The cache memory 20 temporarily stores a prefetched data. The cache memory 20 is, for example, a static random access memory (SRAM). The cache memory 20 may also be a DRAM. A configuration of the CM controller 1 will be described in detail later.

The host interface circuit (host I/F circuit) 3 performs communication between the host device HD and the memory system MS on the basis of the CXL specification. The host interface circuit 3 is configured to be coupled to the host device HD via the host bus HB. The host interface circuit 3 is coupled to the internal bus 9 in the memory controller 400.

The host interface circuit 3 executes various types of processing for data transmission and reception between the host device HD and the memory system MS.

For example, the host interface circuit 3 includes a processing circuit 30 and an interface circuit 31. The processing circuit 30 performs various types of processing in the host interface circuit 3 and controls the operation of the interface circuit 31. Under control of the processing circuit 30, the interface circuit 31 executes various types of processing as a physical layer based on the CXL specification.

The flash memory interface circuit (flash memory I/F circuit) 5 performs communications between the non-volatile memory 300 and the memory controller 400. The flash memory interface circuit 5 is configured to be coupled to the non-volatile memory 300 via a flash bus FB. The flash memory interface circuit 5 is coupled to the internal bus 9 in the memory controller 400.

The flash memory interface circuit 5 executes various types of processing for transmission and reception of data between the non-volatile memory 300 and the memory controller 400. For example, the flash memory interface circuit 5 executes data randomization processing, data encoding/decoding processing, logical address/physical address conversion processing, etc. In a case where the non-volatile memory 300 is a flash memory, for example, the flash memory interface circuit 5 executes interface processing in compliance with the Toggle NAND Flash Interface specification or the Open NAND Flash Interface specification.

For example, the flash memory interface circuit 5 includes a processing circuit 50 and an interface circuit 51. The processing circuit 50 performs various types of processing in the flash memory interface circuit 5 and controls an operation of the interface circuit 51. Under control of the processing circuit 50, the interface circuit 51 executes various types of processing as a physical layer based on an applied interface specification.

The main memory interface circuit 7 controls operation of the main memory 8. The main memory interface circuit 7 is coupled to the internal bus 9. As a result, the main memory 8 is coupled to the internal bus 9 via the main memory interface circuit 7. The main memory interface circuit 7 reads data from the main memory 8 to the internal bus 9. The main memory interface circuit 7 writes data from the host device HD and data from the non-volatile memory 300 to the main memory 8. The main memory interface circuit 7 may be provided outside the memory controller 400.

The host interface circuit 3, the flash memory interface circuit 5, and the internal bus 9 include various layers based on the CXL.mem protocol and the CXL.cache protocol. This enables the host device HD to access the non-volatile memory 300 using the main memory 8 and the cache memory 20 on the basis of the CXL specification.

For example, the memory system MS has intermediate performance between a main memory such as a DRAM and a storage device such as a solid storage drive (SSD). The memory system MS has a larger storage capacity than that of the main memory. An access speed to the memory system MS is higher than an access speed to the storage device. The memory system MS thus can be configured to increase a capacity of the main memory. However, due to a large read latency of the non-volatile memory 300, improvement of a read performance of the memory system MS is desired. Meanwhile, the memory system MS may be an SSD.

### (a-3) Non-Volatile Memory

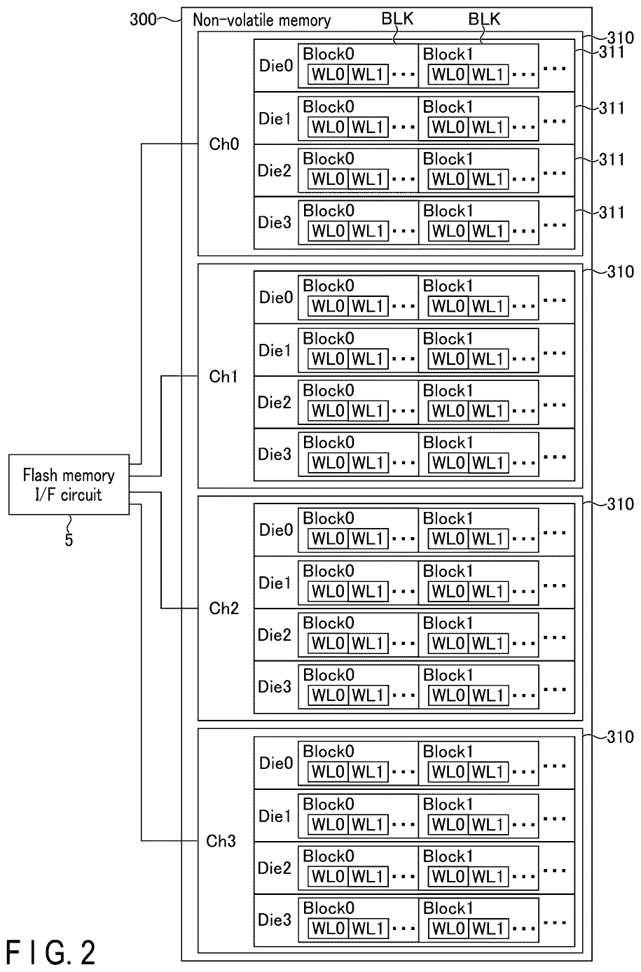

An example of a configuration of the non-volatile memory 300 will be described with reference to FIG. 2.

FIG. 2 is a block diagram schematically showing an example of a configuration of the non-volatile memory 300 in the present embodiment. FIG. 2 illustrates a case where the non-volatile memory 300 is a NAND flash memory.

As described above, the non-volatile memory 300 includes a plurality of memory modules 310. Each of the memory modules 310 communicates with the flash memory interface circuit 5 via a corresponding one of the plurality of channels Ch. The plurality of memory modules 310 operate independently of each other by parallelized channels Ch, respectively.

Each of the memory modules 310 includes the plurality of memory dies 311. For example, four memory dies 311 are provided in one memory module 310. The memory die 311 is, for example, one chip. In one memory module 310, the plurality of memory dies 311 are operable independently of each other and in parallel with each other. Meanwhile, in a case where a plurality of planes are provided in one chip, one plane may be handled as equivalent to one memory die 311. In a flash memory, a plane is a control unit (group of circuits) that is independently operable.

In the non-volatile memory 300, a plurality of blocks BLK are provided in one memory die 311. A block BLK is a data erasure unit in the flash memory.

A plurality of word lines WL (WL0, WL1, . . . ) are provided in each block BLK. A plurality of memory cells are coupled to each word line WL. In the flash memory, reading and writing of data are performed using each word line WL as a unit of each operation.

The flash memory interface circuit 5 monitors an operation state of each memory die 311. The flash memory interface circuit 5 circulates through the memory space of the non-volatile memory 300 in an order set based on, for example, an address of the channel Ch, an address of the memory die 311, and an address of the word line WL. As a result of this circulation, the flash memory interface circuit 5 searches for a word line WL from which data can be read (or from which data can be written). As a result, the flash memory interface circuit 5 accesses the word line WL from which data can be read. In a case where one or more pages are allocated to one word line WL, a data size of data associated with one page is, for example, 64 kilobytes (KB). Meanwhile, access to a word line WL in response to a certain read request is not limited to one physical word line WL, and may be performed on a set of multiple word lines WL (logical word lines WL) that are accessible in parallel.

For example, after a time tR has elapsed from a start of a read operation in response to a command, each memory die 311 can output data read from the word line WL as an access target to the flash memory interface circuit 5. A length of the time tR may differ for each memory die 311.

### (a-4) Cache Memory Controller

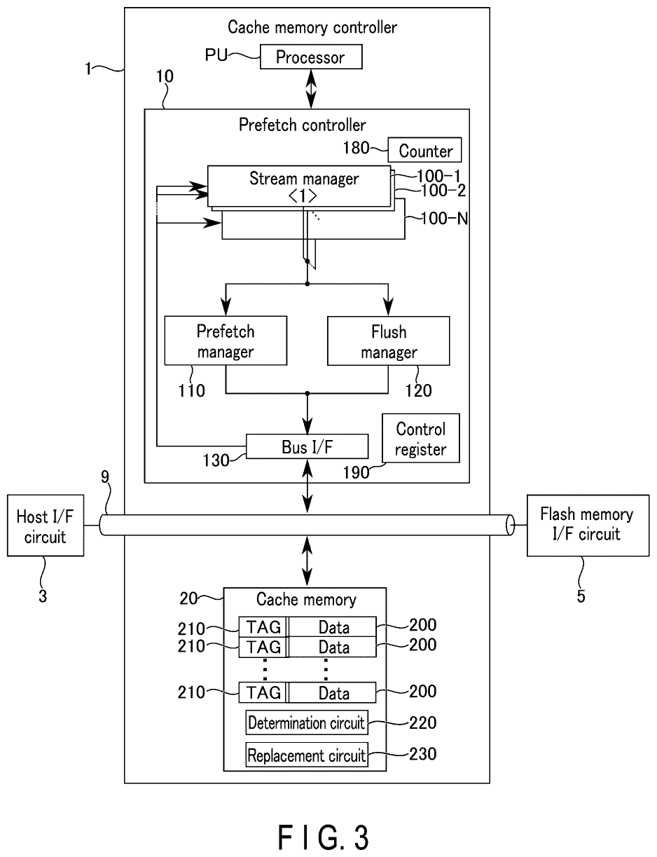

An example of a configuration of the CM controller (cache memory controller) 1 according to the present embodiment will be described with reference to FIG. 3 to FIG. 5.

FIG. 3 is a block diagram showing an example of a configuration of the CM controller 1 according to the present embodiment.

As described above, the CM controller 1 includes the prefetch controller 10 and the cache memory 20.

In the present embodiment, the prefetch controller 10 has a mechanism capable of tracking a plurality of streams that are simultaneously transferred in order to prefetch (cache) data included in a stream in response to a request from the host device HD. The stream is a collection of a plurality of data units. For example, a transfer of a stream occurs in a case where sequential data with a relatively large data size is read from the non-volatile memory 300 in response to a read request from the host device HD.

The prefetch controller 10 includes a plurality of stream managers 100 (100-1, 100-2, . . . , 100-N), a prefetch manager 110, a flush manager 120, a bus interface (bus I/F) 130, a counter 180, and a control register 190.

In a case where a data transfer occurs between the host device HD and the memory system MS, each of the plurality of stream managers 100 detects whether or not data involved in the data transfer corresponds to a stream. In a case where the stream manager 100 detects a stream, the stream manager 100 manages the detected stream.

The stream manager 100 detects a stream on the basis of a given algorithm regarding a data transfer state in the internal bus 9. The stream manager 100 monitors a state of the detected stream on the basis of a window size (data bandwidth) regarding a transfer of a plurality of data units included in the stream and/or a transition time between data units.

The prefetch manager 110 manages and controls a prefetch operation for prefetching data included in the detected stream into the cache memory 20. The prefetch manager 110 calculates a prefetch amount of data according to the number of detected streams. As a result, the prefetch manager 110 adjusts the prefetch amount to a more appropriate value according to the number of streams transferred in response to a read request from the host device HD. The prefetch manager 110 executes a data prefetch operation according to the adjusted prefetch amount. Hereinafter, data prefetched to the cache memory 20 will also be referred to as “prefetched data”.

The flush manager 120 manages and controls a cache flush operation for discharging data from the cache memory 20. In a case where prefetched data becomes garbage due to a degeneration of the stream, the flush manager 120 flushes (evicts) corresponding prefetched data from the cache memory 20. As a result, the prefetched data relating to the degenerated stream is erased from the cache memory 20. Herein, the degeneration of the stream indicates that the data transfer of streams is nearly complete.

The bus interface 130 is an interface circuit between the internal bus 9 and each of the managers 100, 110, and 120. The bus interface 130 notifies the stream manager 100, the prefetch manager 110, and the flush manager 120 of a data transfer state on the basis of a result of monitoring the internal bus 9 by bus snooping. For example, the bus interface 130 can notify the stream manager 100 of an address of an access target, a data size, a data transfer speed, etc. The bus interface 130 notifies the cache memory 20 of a control for the prefetch operation by the prefetch manager 110 and a control for the flush operation by the flush manager 120 via the internal bus 9.

The counter 180 measures various times (cycles) used for various controls by the CM controller 1 on the basis of a clock signal in the CM controller 1 or in the memory system MS.

The control register 190 stores various set values (control information) for detecting/managing a stream, managing/controlling the prefetch operation, and managing/controlling the cache flush operation.

For example, the CM controller 1 further includes a processor PU. The processor PU can perform control of various operations of the prefetch controller 10, control of each of the managers 100, 110, and 120, and various types of calculation processing. For example, the processor PU executes conversion processing of logical addresses and physical addresses in various requests from the host device HD. Meanwhile, the prefetch controller 10 may include the processor PU. Furthermore, the prefetch controller 10 may perform processing to equivalent that of the processor PU. For example, the prefetch controller 10 may perform the control of each of the managers 100, 110, and 120 and the conversion processing of logical addresses and physical addresses.

The stream manager 100, the prefetch manager 110, and the flush manager 120 may be hardware (circuits), software (firmware, programs, applications), or a combination of hardware and software.

The cache memory 20 includes a plurality of data memories 200, a plurality of tag memories 210, a determination circuit 220, and a replacement circuit 230.

Each of the plurality of data memories 200 is a data storage area that stores prefetched data of a given data size. One data memory 200 can store, for example, data of 64 bytes (B).

Each of the plurality of tag memories 210 is a data storage area that stores tag information TAG including information on an address from which the prefetched data is read, a state of data in each data memory 200, various types of control information, etc. Each tag memory 210 is associated with each data memory 200 on a one-to-one basis.

The determination circuit 220 determines whether a cache has been hit or missed on the basis of the tag information TAG and an address of data serving as a read target in the non-volatile memory 300. In a case where the cache has been hit, the cache memory 20 is accessed and data is read from the target data memory 200.

In a case of a cache miss, the replacement circuit 230 replaces data in a given data memory 200 with data newly read from the non-volatile memory 300.

In a case where the host device HD requests reading of data with a relatively large data size, such as sequential data, a transfer of wide-band streams occurs between the non-volatile memory 300 and the host device HD.

The CM controller 1 according to the present embodiment detects streams more appropriately using the stream manager 100. The CM controller 1 according to the present embodiment adjusts the prefetch amount according to the number of detected streams using the prefetch manager 110, and prefetches data included in the detected streams.

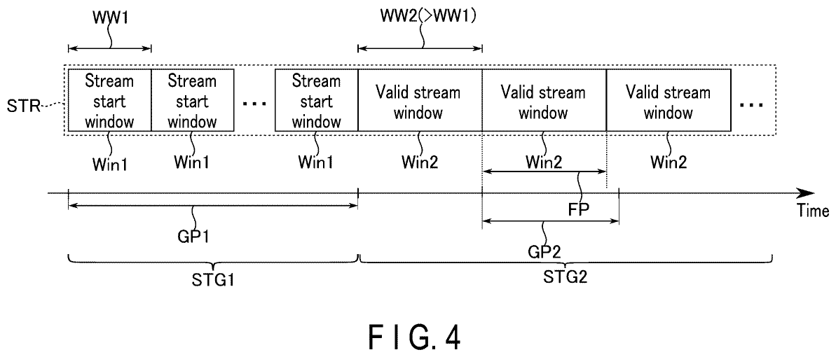

FIG. 4 is a schematic diagram for illustrating detection of a stream by the CM controller 1 according to the present embodiment.

As shown in FIG. 4, a transfer of one stream STR includes a plurality of windows Win1 and a plurality of windows Win2. Each of the windows Win1 and Win2 correspond to a transfer period of a data unit included in one stream STR.

Each window Win1 is a unit for monitoring a transfer state of data read from non-volatile memory 300 in a period (stage) from a start of a transfer of stream STR to a given time. The window Win1 has a given window size (data size) WW1. For example, a window size WW1 is several tens of bytes (B) to several hundreds of bytes. Hereinafter, the window Win1 will also be referred to as a “stream start window Win1”. For example, the window Win1 may correspond to an amount of data transferred in a given unit of time.

In the CM controller 1, in a case where the predetermined number of stream start windows Win1 are transferred successively within a given period (time limit), the prefetch controller 10, which operates based on a given algorithm, determines that the data transfer including these stream start windows Win1 is a transfer of a valid stream STR. Hereinafter, this given period will be referred to as a “stream start grace period GP1”. For example, the stream start grace period GP1 may be measured by the counter 180.

In a case where the number of successive windows Win1 to be transferred within the stream start grace period GP1 is smaller than a predetermined number, the prefetch controller 10 in the CM controller 1 determines that the data transfer is not the transfer of the stream STR.

In this way, the CM controller 1 according to the present embodiment detects the stream STR on the basis of a continuity of the windows Win1 of a predetermined data size in a given period (stream start grace period GP1).

In read access in response to a read request from the host device HD, data is output from the non-volatile memory 300. A period from the start of data transfer in the read access until the data is determined to be the valid stream STR will be referred to as a “stream start stage STG1” (or simply a “start stage STG1”). For example, the length of the stream start stage STG1 may be equal to the length of the stream start grace period GP1.

The window Win2 is a unit for monitoring a transfer state of data read from the non-volatile memory 300 in a period (stage) after the stream STR is determined to be valid. The window Win2 has a given window size (data size) WW2. The window size WW2 is larger than the window size WW1. For example, the window size WW2 is several kilobytes to several tens of kilobytes. Hereinafter, the window Win2 will also be referred to as a “valid stream window Win2”. The period after a given stream (data transfer) is determined to be the valid stream STR will be referred to as a “valid stream stage STG2” (or simply a “valid stage STG2”). The valid stream stage STG2 is a period (stage) after the stream start stage STG1. For example, the length of the valid stream stage STG2 is longer than a length of the stream start stage STG1.

The window Win2 may correspond to an amount of data transferred in a given unit of time. A unit time allocated to the window Win2 is different from a unit time allocated to the window Win1.

A size of data output from the non-volatile memory 300 in response to the read access has a fluctuation range for a given period. The window sizes WW1 and WW2 have values that are set in consideration of the fluctuation in the size of data output in response to the read access.

In a case where the prefetch controller 10 detects that a transition period from the preceding valid stream window Win2 to the next valid stream window Win2 is longer than a given period (time limit), the CM controller 1 determines that the corresponding stream STR is in a declining state. In a case where the transition period is equal to or less than a given period (time limit), the CM controller 1 keeps the determination that the corresponding stream STR is valid. Hereinafter, the transition period will be referred to as a “valid stream window transition period FP”. For example, the valid stream window transition period FP corresponds to a period from the start of transfer (access) of a valid stream window Win2 to the start of transfer of the next valid stream window Win2. For example, the valid stream window transition period FP may be measured by the counter 180. Hereinafter, the given period (time limit) will be referred to as a “valid stream grace period GP2”.

The degeneration of the stream STR indicates that a large-scale and high-speed data transfer including successive windows Win1 and Win2 for transferring the plurality of data units based on a request from the host device HD is about to end.

In this way, the CM controller 1 according to the present embodiment detects the stream STR and determines the state of the detected stream STR by monitoring the data transfer state of the plurality of windows Win1 and Win2 in the set periods GP1 and GP2.

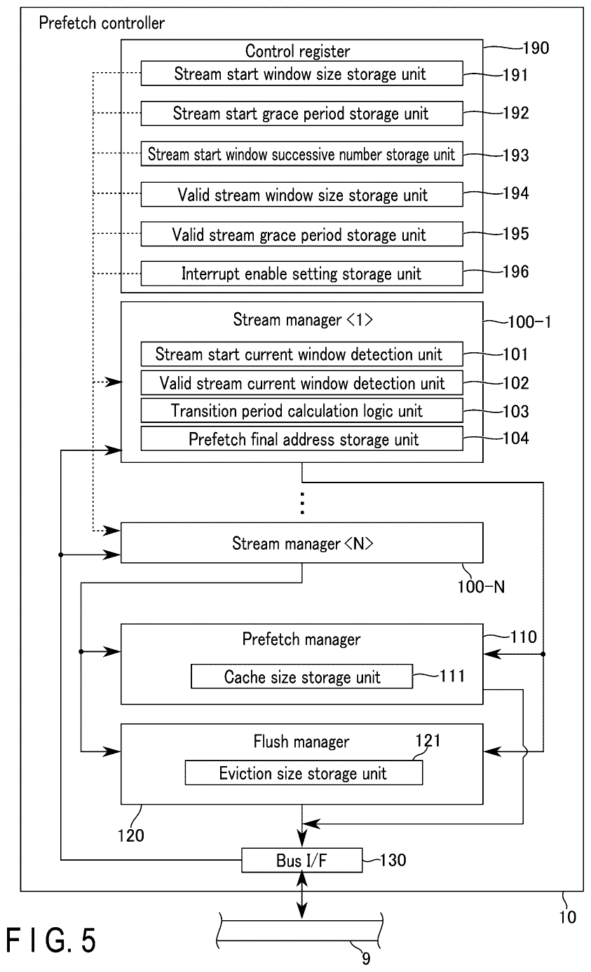

FIG. 5 is a block diagram showing a functional configuration of the CM controller 1 according to the present embodiment.

As shown in FIG. 5, in the CM controller 1 according to the present embodiment, the prefetch controller 10 includes a stream start window size storage unit 191, a stream start grace period storage unit 192, a stream start window successive number storage unit 193, a valid stream window size storage unit 194, a valid stream grace period storage unit 195, and an interrupt enable setting storage unit 196. These storage units 191 to 196 are configured by using the control register 190. Stored values of the storage units 191 to 196 are supplied to each of the plurality of stream managers 100.

The stream start window size storage unit 191 stores a set value of the window size WW1 of the stream start window Win1. Based on this set value, the stream manager 100 monitors the stream start window Win1.

The stream start grace period storage unit 192 stores a set value of the stream start grace period GP1. Based on this set value, the stream manager 100 monitors a data transfer state of the plurality of windows Win1 in the stream start stage GP1.

The stream start window successive number storage unit 193 stores a threshold value with respect to a successive number of stream start windows Win1 in the data transfer that is in execution. The stream manager 100 determines whether or not the data transfer that is in execution corresponds to the stream STR through calculation processing using the aforementioned threshold value and the successive number of stream start windows Win1.

The valid stream window size storage unit 194 stores a set value of the window size WW2 of the valid stream window Win2. Based on this set value, the stream manager 100 monitors the valid stream window Win2.

The valid stream grace period storage unit 195 stores a set value of the valid stream grace period GP2. Based on this set value, the stream manager 100 monitors a data transfer state of the plurality of windows Win2 in the valid stream stage GP2.

The interrupt enable setting storage unit 196 stores a set value indicating whether or not to permit interrupt processing of the transfer of a new stream STR with respect to the stream STR that is in process in a case where a new stream STR is detected and there is no available stream manager 100. Whether or not to permit interrupt processing of the transfer of the stream STR is indicated by a 1-bit value. For example, in a case where the set value of the interrupt enable setting storage unit 196 is “0”, the interrupt processing of the transfer of a new stream STR is not permitted. For example, in a case where the set value of the interrupt enable setting storage unit 196 is “1”, the interrupt processing of the transfer of a new stream STR is permitted.

The values stored in the storage units 191 to 196 can be set to any values depending on the specifications of the memory system MS and the information processing system PS.

Each of the N stream managers 100-1, . . . , and 100-N includes a stream start current window detection unit 101, a valid stream current window detection unit 102, a transition period calculation logic unit 103, and a prefetch final address storage unit 104.

The stream start current window detection unit 101 detects and stores a logical address or an address value (physical address) in the non-volatile memory 300 which corresponds to the current stream start window Win1 to be monitored.

The valid stream current window detection unit 102 detects and stores a logical address or an address value in the non-volatile memory 300 which corresponds to the current valid stream window Win2 to be monitored.

The transition period calculation logic unit 103 calculates the period FP during which a transition from the current valid stream window Win2 to a next valid stream window Win2 has occurred in the valid stream STR to be managed. For example, the transition period calculation logic unit 103 calculates the window transition period based on a period during which the window Win2 to be accessed is changed.

The prefetch final address storage unit 104 stores a logical address or an address value in the non-volatile memory 300 which corresponds to a last prefetched data. This address will also be referred to as a “prefetch final address”.

Each stream manager 100 manages the stream STR based on various values in the stream manager 100, various values in the control register 190, and various values obtained via the bus interface 130. Each stream manager 100 executes various types of calculation processing for controlling the prefetch operation and the flush operation.

In reading data in response to a read request from the host device HD, identification numbers may be assigned to the windows Win1 and Win2 in order to identify the association between read access and the windows Win1 and Win2 corresponding to the read access. The identification numbers may be stored in the corresponding storage units instead of addresses, or may be used for various types of processing.

The prefetch manager 110 includes a cache size storage unit 111.

The cache size storage unit 111 stores a value indicating the storage capacity of the cache memory 20.

The prefetch manager 110 calculates the prefetch amount of data on the basis of processing results of the plurality of stream managers 100 and the storage capacity of the cache memory 20. The prefetch manager 110 executes a prefetch operation with respect to data of one or more stream STRs on the basis of the calculated prefetch amount. As a result, the prefetched data of the stream STR is prefetched into the cache memory 20.

The flush manager 120 includes an eviction size storage unit 121.

The eviction size storage unit 121 stores a value indicating a size of data to be discharged from the cache memory 20 through a cache flush operation. This size will also be referred to as a “cache eviction size”.

The flush manager 120 executes the cache flush operation of the cache memory 20 on the basis of the processing results of the plurality of stream managers 100 and the set eviction size. As a result, the prefetched data of the corresponding stream STR is erased from the cache memory 20.

### (b) Example of Operation

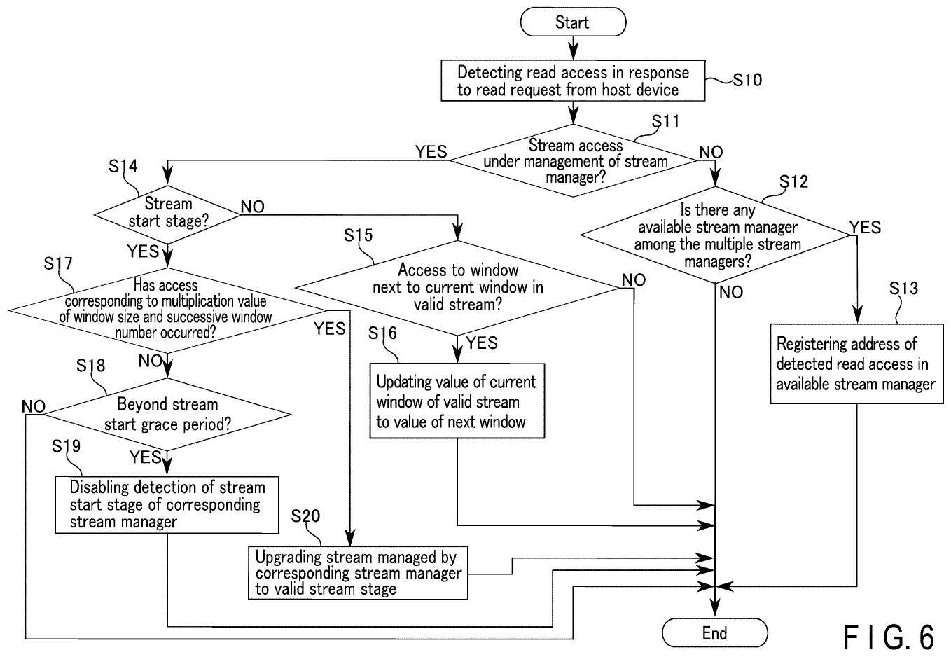

An example of operations of the CM controller 1 according to the present embodiment will be described with reference to FIGS. 6 to 9. Examples of the operation of the CM controller 1 according to the present embodiment may be included in the control method of the CM controller 1 according to the present embodiment.

### (B-1) Detection of Stream

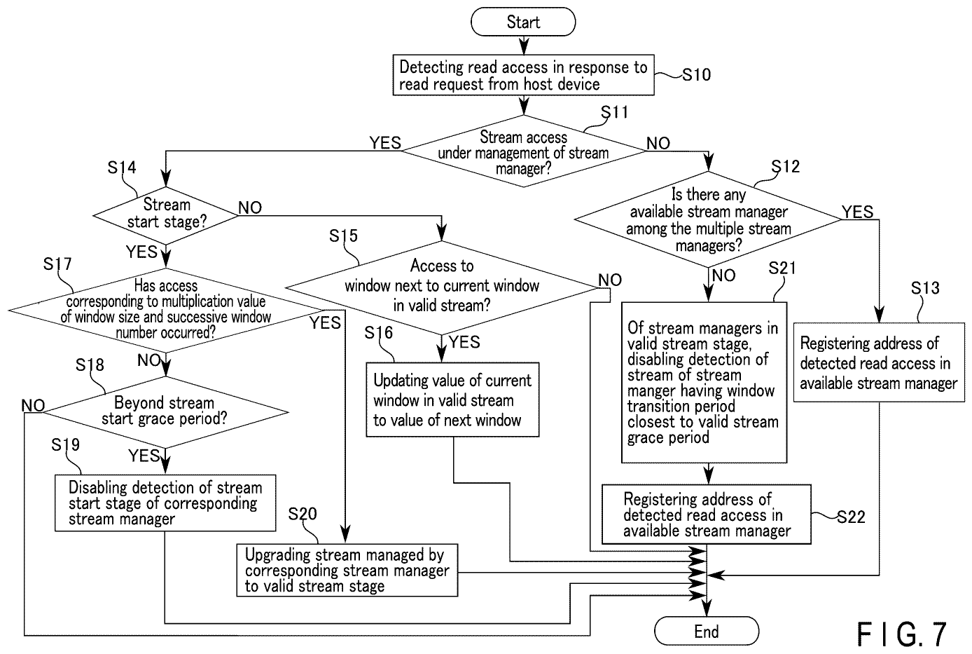

Examples of the operation for detecting a stream in the CM controller 1 according to the present embodiment will be described with reference to FIG. 6 and FIG. 7.

### (b-1-1> Example 1

An example of the operation of the CM controller 1 according to the present embodiment will be described with reference to FIG. 6. FIG. 6 is a flowchart showing an example of a detection operation of the stream STR in the CM controller 1 according to the present embodiment. FIG. 6 shows an example of the detection operation of the stream STR performed by the CM controller 1 in a case where the interrupt processing of the transfer of a stream STR newly generated is not permitted (in a case where a set value of the interrupt enable setting storage unit 196 is equal to 0).

### S10

The CM controller 1 detects read access to the non-volatile memory 300 in response to a read request from the host device HD.

### S11

The CM controller 1 verifies whether the detected read access is access corresponding to a stream STR currently managed by the stream manager 100, for example, based on an address (or an identification number) of the window corresponding to the read access.

### S11-NO, S12

In a case where the detected read access is not read access corresponding to the stream STR currently managed, the CM controller 1 checks whether or not the stream manager 100 that is not currently operating (an available stream manager) is present.

### S12-NO

In a case where no stream manager 100 is available, the CM controller 1 terminates the processing with respect to the detected read access.

### S12-YES, S13

In a case where an available stream manager 100 is present, the CM controller 1 registers an address of a window corresponding to the detected read access in the stream start current window detection unit 101 of the available stream manager 100.

As a result, the available stream manager 100 (the stream manager whose address has been newly registered) starts detection of the start stage STG1 of the stream STR corresponding to the detected read access.

### S11-YES, S14

In a case where the detected read access is read access corresponding to the stream STR currently managed, the CM controller 1 determines whether or not a management state of the stream STR corresponding to the detected read access corresponds to detection of the start stage STG1 of the stream STR.

For example, in the CM controller 1, the corresponding stream manager 100 checks a value of the stream start current window detection unit 101 and a value of the valid stream current window detection unit 102.

### S14-NO, S15

In a case where a management state of the stream STR corresponding to the detected read access does not correspond to detection of the start stage STG1 of the stream STR (in a case where the management state of the stream STR corresponding to the detected read access corresponds to detection of the valid stage STG2 of the stream STR), the CM controller 1 determines, on the basis of a value of the valid stream current window detection unit 102, whether or not detected read access is read access corresponding to a next window Win2 of the current window Win2 of the corresponding stream (valid stream) STR.

### S15-YES, S16

In a case where the detected read access is read access corresponding to the next window Win2 of the current window Win2 of the valid stream STR, the CM controller 1 changes a value of the current window Win2 of the valid stream STR to a value of the next window Win2 in accordance with a set value in the valid stream window size storage unit 194. In the CM controller 1, the corresponding stream manager 100 updates a value of the valid stream current window detection unit 102 from a value (address value or identification number) corresponding to the current window Win2 to a value corresponding to the next window Win2. After this, the CM controller 1 terminates the processing with respect to the detected read access.

### S15-NO

In a case where the detected read access is not read access corresponding to the next window Win2 of the current window Win2 of the valid stream STR, the CM controller 1 terminates the processing with respect to the detected read access.

### S14-YES, S17

In a case where a management state of the stream STR corresponding to the detected read access corresponds to detection of the start stage STG1 of the stream STR, the CM controller 1 checks whether or not access (data transfer) with a data size corresponding to a multiplication value of the window size WW1 at the start of the stream and the number of successive windows at the start of the stream has occurred.

For example, in the CM controller 1, the corresponding stream manager 100 multiplies a set value in the stream start window size storage unit 191 by a set value in the stream start window successive number storage unit 193. The corresponding stream manager 100 compares a value obtained by the multiplication with a size (a set of the plurality of windows Win1) of data transferred in the read access.

### S17-NO, S18

In a case where access with a data size corresponding to the multiplication value of the window size WW1 at the start of the stream and the number of successive windows at the start of the stream has not occurred, the CM controller 1 determines whether or not a period of target read access exceeds the stream start grace period GP1.

For example, in the CM controller 1, the corresponding stream manager 100 compares a set value (stream start grace period GP1) in the stream start grace period storage unit 192 with the period of the target read access.

### S18-NO

In a case where the period of the target read access does not exceed the stream start grace period GP1, the CM controller 1 determines that the data transfer corresponding to the aforementioned read access is not a stream STR at the current stage because a data size transferred during the period of the target read access is also smaller than the multiplication value of the set value in the stream start window size storage unit 191 and the set value in the stream start window successive number storage unit 193. The stream manager 100 continues to detect the streams STR in the stream start stage STG1. As a result, the CM controller 1 terminates the processing with respect to the detected read access.

### S18-YES, S19

In a case where the period of the target read access exceeds the stream start grace period GP1, the CM controller 1 determines that the read access is not access relating to the stream STR. In this case, the CM controller 1 disables detection of the stream start stage STG1 of the corresponding stream manager 100. The corresponding stream manager 100 is set to an available state. For example, the values of the detection units 101 and 102 of the corresponding stream manager 100 are reset. As a result, the CM controller 1 terminates the processing with respect to the detected read access.

### S17-YES, S20

In a case where access with a data size corresponding to the multiplication value of the window size WW1 and the number of successive windows in the stream start stage STG1 has occurred, the CM controller 1 upgrades a management state of the stream STR corresponding to the access from the stream start stage STG1 to the valid stream stage STG2. As a result, in the CM controller 1, the corresponding stream manager 100 starts management of the valid stream. The CM controller 1 terminates the processing with respect to the detected read access.

In the manner described above, the processing for detecting the stream STR in the CM controller 1 according to the present embodiment is completed.

As described with reference to FIG. 6, in a case where read access is detected, the CM controller 1 according to the present embodiment detects whether or not the data transfer corresponding to the aforementioned read access is the transfer of the stream STR. In addition, the CM controller 1 according to the present embodiment determines a state of the transfer of the stream STR according to the data transfer state of the windows.

This enables the CM controller 1 according to the present embodiment to detect the stream STR more appropriately.

### (B-1-2) Example 2

An example of the operation of the CM controller 1 according to the present embodiment will be described with reference to FIG. 7. FIG. 7 is a flowchart showing another example of the detection operation of the stream STR in the controller 1 according to the present embodiment. FIG. 7 shows an example of the detection operation of the stream STR performed by the CM controller 1 in a case where the interrupt processing of the transfer of a stream STR newly generated is permitted (in a case where a setting value of the interrupt enable setting storage unit 196 is equal to 1). An example of the operation shown in FIG. 7 performs almost the same processing as that of the example of the operation shown in FIG. 6, but some of the processing is different. The following mainly describes the difference from FIG. 6.

### S12-NO, S21

In a case where a set value in the interrupt enable setting storage unit 196 is equal to 1 and no stream manager 100 is available, the CM controller 1 disables the operation of the stream manager 100 of the declining stream STR among one or more stream managers 100 each managing the valid stream STR.

For example, the CM controller 1 disables the operation (management of the detected stream STR) of a stream manager 100 which is included in one or more stream managers 100 and whose window transition period calculation value is closest to the valid stream grace period GP2.

As a result, the stream manager 100 corresponding to the disabled stream STR becomes available.

### S22

The CM controller 1 registers a new stream STR corresponding to the detected read access in the available stream manager 100. The CM controller 1 records an address of the window corresponding to the detected read access in the stream start current window detection unit 101 of the available stream manager 100.

This causes the available stream manager 100 to start detection of the start stage STG1 of the stream STR corresponding to the detected read access.

The CM controller 1 terminates the processing with respect to the detected read access.

In this way, in a case where the interrupt processing of the transfer of the stream STR newly generated is executable, the CM controller 1 stops managing the valid stream that will soon be invalidated, and starts managing the new stream STR.

### (b-2) Prefetch Operation of Valid Stream

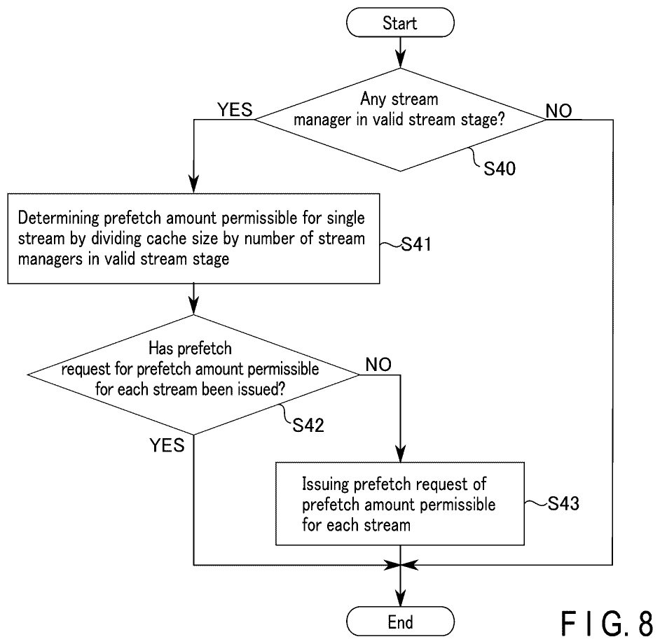

An example of the operation for the prefetch operation of the valid stream in the CM controller 1 according to the present embodiment will be described with reference to FIG. 8.

FIG. 8 is a flowchart showing an example of the prefetch operation in the CM controller 1 according to the present embodiment.

### S40

As shown in FIG. 8, the CM controller 1 checks whether or not the stream manager (a stream manager that manages a valid stream) 100 in the valid stream stage STG2 is present.

### S40-NO

In a case of no stream manager 100 in the valid stream stage STG2, the CM controller 1 terminates various types of processing for the prefetch operation.

### S40-YES, S41

In a case where the stream manager 100 in the valid stream stage STG2 is present, the CM controller 1 divides a cache size (the storage capacity of the cache memory 20) by the number of stream managers 100 in the valid stream stage STG2. For example, the cache size is presented by a value of the cache size storage unit 111 of the prefetch manager 110.

In this way, the CM controller 1 determines the prefetch amount permitted for one stream STR.

### S42

The CM controller 1 checks whether or not a prefetch request of the prefetch amount permitted for each stream STR has been issued.

### S42-YES

If the prefetch request has already been issued, the CM controller 1 determines that the prefetch operation has already been executed, and terminates various types of processing for the prefetch operation.

### S42-NO, S43

In a case where a prefetch request has not been issued, the CM controller 1 issues the prefetch request. The prefetch request includes information indicating the prefetch amount permitted for each stream STR.

In the CM controller 1, the prefetch manager 110 executes the prefetch operation in response to the prefetch request. In response to the prefetch request and the control by the prefetch manager 110, the cache memory 20 prefetches data included in each stream STR (windows Win1 and Win2) by the calculated prefetch amount.

After issuing the prefetch request, the CM controller 1 terminates the processing relating to the prefetch operation.

As described above, the CM controller 1 completes various types of processing for the prefetch operation.

The CM controller 1 according to the present embodiment calculates the prefetch amount for prefetching data of each stream STR on the basis of the number of streams STR currently being managed and the storage capacity of the cache memory 20.

This enables the CM controller 1 according to the present embodiment to prefetch data of each of the plurality of streams STR into the cache memory 20 by a prefetch amount that is more appropriate for the storage capacity of the cache memory 20.

### (b-3) Eviction Operation of Cache Memory

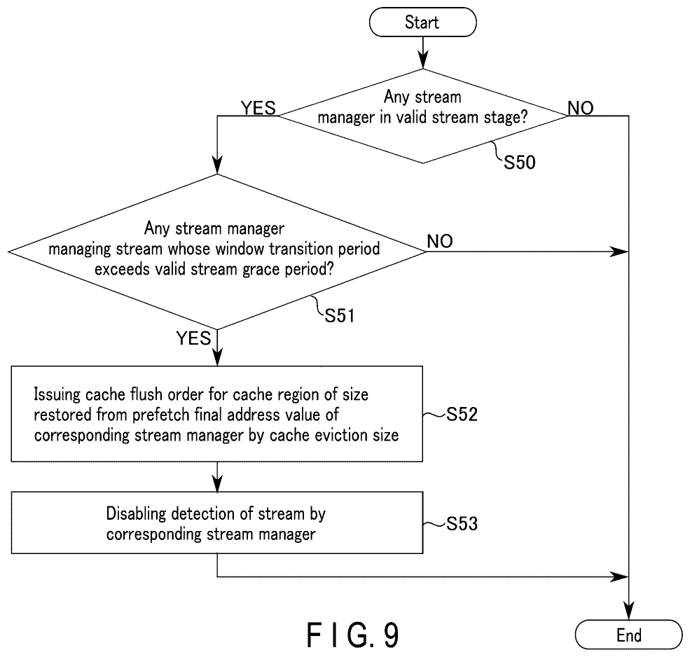

An example of the operation for an eviction operation of the cache memory 20 in the CM controller 1 according to the present embodiment will be described with reference to FIG. 9.

FIG. 9 is a flowchart showing an example of the eviction operation in the CM controller 1 according to the present embodiment.

### S50

As shown in FIG. 9, the CM controller 1 checks whether or not the stream manager 100 in the valid stream stage STG2 is present.

### S50-NO

In a case of no stream manager 100 in the valid stream stage STG2, the CM controller 1 terminates various types of processing for the eviction operation.

### S50-YES, S51

In a case where the stream manager 100 in the valid stream stage STG2 is present, the CM controller 1 checks whether or not there is a stream manager 100 that manages a stream STR whose window transition period FP exceeds the valid stream grace period GP2 among one or more stream managers 100 in the valid stream stage STG2.

In one or more stream managers 100 in the valid stream stage STG2, the transition period calculation logic unit 103 calculates the window transition period FP. The window transition period FP is obtained by calculating the period from the start of access of the current window Win2 to the start of access of the next window Win2 on the basis of the window size WW2. The current window Win2 is presented by a value in the valid stream current window detection unit 102.

### S51-NO

If there is no stream manager 100 that manages the stream STR whose window transition period FP exceeds the valid stream grace period GP2, the CM controller 1 determines various types of processing for the eviction operation.

### S51-YES, S52

If there is a stream manager 100 that manages the stream STR whose window transition period FP exceeds the valid stream grace period GP2, the CM controller 1 determines that the stream STR of the corresponding stream manager 100 is in a declining state.

The CM controller 1 issues a cache flush order for a cache region (one or more data memories 200) corresponding to a size restored from a prefetch final address value of the corresponding stream manager 100 by the cache eviction size.

The prefetch final address value is presented by a value of the prefetch final address storage unit 104 of the stream manager 100. The cache eviction size is presented by a value of the eviction size storage unit 121 of the flush manager 120.

On the basis of the issued cache flush order, the flush manager 120 executes the cache flush operation on the cache region targeted for the eviction operation in the cache memory 20. As a result, the corresponding data in the cache memory 20 is evicted.

### S53

The CM controller 1 disables detection of the stream STR by the corresponding stream manager 100. The stream manager 100 whose detection of the stream STR has been disabled becomes available.

As described above, the CM controller 1 completes various types of processing for the eviction operation of the cache memory 20.

The CM controller 1 according to the present embodiment determines whether or not the corresponding stream STR is in a declining state on the basis of the transition period FP of the window Win2 in the valid stream STR. In the present embodiment, in a case where the degeneration of the stream STR is detected, the CM controller 1 evicts the prefetched data corresponding to the stream STR from the cache memory 20. As a result, the prefetched data that has become garbage is erased from the cache memory 20.

Therefore, the CM controller 1 according to the present embodiment can manage a data storage state of the cache memory 20 according to the state of the stream STR.

### (c) Summary

In a case where the transfer of many wide-band (e.g., GB/s class) streams has occurred in response to the read request from the host device, the cache memory controller prefetches data that constitutes streams into the cache memory in order to conceal the read time from the non-volatile memory. The prefetch of data is executed at a timing prior to the read request from the host device in order to prevent the occurrence of a cache miss.

If detection of a stream is executed using a simple algorithm or adjustment of the prefetch amount with respect to a stream is not performed, there is a possibility that a cache thrashing phenomenon will occur. In a case where cache thrashing phenomenon occurs, a read bandwidth of the host device decreases.

The memory controller (cache memory controller) 1 according to the present embodiment detects the occurrence of the transfer of the stream STR on the basis of the multiplication result of the window size WW1 of the window Win1 and the successive number of windows Win1 within a given period GP1 at the beginning of the data transfer, among the plurality of windows Win1 and Win2 included in the data transfer generated in response to the read request from the host device HD.

This allows the CM controller 1 according to the present embodiment to properly detect a wide-band stream STR with a large data size to be read.

The CM controller 1 according to the present embodiment adjusts the prefetch amount of data that constitutes the streams STR on the basis of the number of detected streams STR and the size of the cache memory 20.

This allows the CM controller 1 according to the present embodiment to prefetch data of one or more streams STR into the cache memory 20 by the appropriate prefetch amount.

As a result of the above, the CM controller 1 according to the present embodiment can suppress the occurrence of the cache thrashing phenomenon.

Therefore, the CM controller 1 according to the present embodiment can achieve the data transfer with a high read bandwidth.

The CM controller 1 according to the present embodiment detects the degeneration of a valid stream STR on the basis of a transfer state of the window Win2 of the valid stream STR. The CM controller 1 according to the present embodiment executes eviction (cache flush operation) of prefetched data relating to the degenerated stream STR on the cache memory 20.

This allows the CM controller 1 according to the present embodiment to evict (erase) from the cache memory 20 the prefetched data that has become garbage due to the degeneration of the stream STR.

As a result, the CM controller 1 according to the present embodiment can prevent a decrease in the read bandwidth of the stream STR.

For example, in a case where the read access of 16 streams STR occurs in response to the read request from the host device, the memory system MS including the CM controller 1 according to the present embodiment can execute the data transfer with a read bandwidth of 6 GB/s. The read bandwidth in a memory system including a typical cache memory controller is about 1 GB/s.

As described above, the CM controller 1 according to the present embodiment can improve the performance of data transfer.

### (2) Second Embodiment

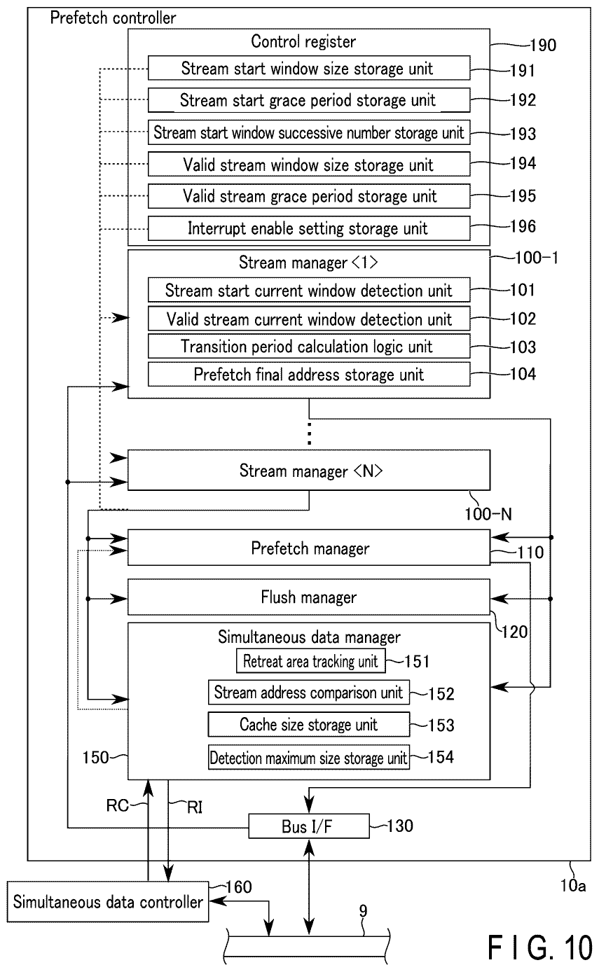

A memory controller and a control method of the memory controller according to a second embodiment will be described with reference to FIG. 10 to FIG. 12.

### (a) Example of Configuration

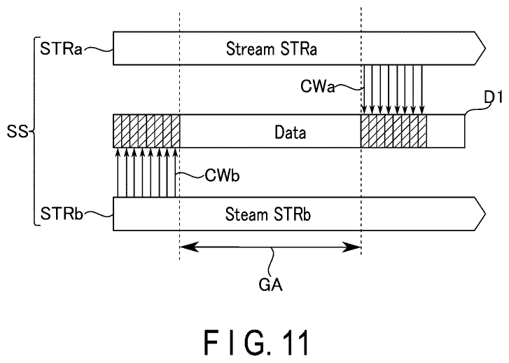

An example of a configuration of a CM controller 1 according to the present embodiment will be described with reference to FIG. 10 and FIG. 11.

FIG. 10 is a block diagram showing a functional configuration of the CM controller 1 according to the present embodiment.

As shown in FIG. 10, in the CM controller 1 according to the present embodiment, a prefetch controller 10a further includes a simultaneous data manager 150 as compared to the prefetch controller 10 shown in FIG. 5. Furthermore, the CM controller 1 according to the present embodiment further includes a simultaneous data controller 160.

The simultaneous data manager 150 can detect a simultaneous stream (simultaneous stream set). In a case of detecting a simultaneous stream, the simultaneous data manager 150 manages data constructed from a plurality of streams in the simultaneous stream.

Herein, the simultaneous stream will be described. FIG. 11 is a schematic diagram for illustrating the simultaneous stream.

In the present embodiment, the simultaneous stream SS includes two or more streams STR (STRa, STRb). The data transfer of the two streams STRa and STRb is performed in parallel.

The simultaneous stream SS processes a single piece of data (hereinafter also referred to as “simultaneous data”) D1 as data units for each of the two streams STRa and STRb.

Depending on the timing when the transfer of the stream STR occurs, a time gap GA occurs between a read access (address) corresponding to a current window of the earlier stream STRa and a read access (address) corresponding to a current window of the later stream STRb. The time gap GA is calculated, for example, from a difference between an address of a current window CWa of the earlier stream STRa and an address of a current window CWb of the later stream STRb. The time gap GA corresponds to a difference in size between data already read from the earlier stream STRa and data already read from the later stream STRb.

There is a possibility that data that has already been read from the earlier stream STRa may be data that will be read in the future from the later stream STRb.

In a case where the gap GA between the earlier stream STRa and the later stream STRb increases, there is a possibility that the size of the prefetched data shared by the two streams STRa and STRb may become larger than the storage capacity of the cache memory 20. In this case, there is a possibility that data read from the preceding stream STRa may be lost from the cache memory 20.

In reading the data D1 from the simultaneous stream SS, in a case where a value based on the difference between the addresses corresponding to the current windows (read access) of the two streams STRa and STRb becomes larger than a value based on the storage capacity (cache size) of the cache memory 20, the CM controller 1 according to the present embodiment saves the prefetched data in the cache memory 20 to the main memory 8.

The time gap GA between the two streams STRa and STRb is detected by comparing (address difference) the address corresponding to the current window (read access) Win2 of the earlier stream STRa with the address corresponding to the current window Win2 of the later stream STRb. Based on this gap GA, the CM controller 1 according to the present embodiment can relatively calculate the size of the prefetched data obtained from the earlier stream STRa (or the size of the prefetched data of the later stream STRb that may be obtained in the future).

The simultaneous data manager 150 in FIG. 10 includes a retreat area tracking unit 151, a stream address comparison unit 152, a cache size storage unit 153, and a detection maximum size storage unit 154.

The retreat area tracking unit 151 stores an address of an area in the main memory 8 (hereinafter referred to as an “retreat area”) that stores data retreated (saved, evacuated) from the cache memory 20. This enables the CM controller 1 to read data saved in the main memory 8. Hereinafter, data retreated from the cache memory 20 to the main memory 8 will also be referred to as “retreated data”.

The stream address comparison unit 152 compares addresses corresponding to the current windows Win1 and Win2 of the streams STR respectively managed by the plurality of stream managers 100. The CM controller 1 compares the addresses, thereby detecting whether or not the transfer of the simultaneous stream SS has occurred.

The cache size storage unit 153 stores a value of the cache size of the cache memory 20.

The detection maximum size storage unit 154 stores a determination value based on which two streams are regarded as the simultaneous stream SS. In one example, the determination value corresponds to the maximum value of the difference between the addresses of the current windows of the two streams. In a case where the difference between the addresses of the two streams STRa and STRb corresponding to the current windows Win1 and Win2 is equal to or smaller than the aforementioned determination value, it is considered that the two streams STRa and STRb form the simultaneous stream SS.

In a case where the occurrence of transfer of the simultaneous stream SS is detected, the simultaneous data manager 150 issues to the simultaneous data controller 160 a retreat instruction RI of data from the cache memory 20 to the main memory 8, directly or via the internal bus 9. For example, the retreat instruction RI includes information on an area in the cache memory 20 in which data to be retreated is stored.

The simultaneous data controller 160 communicates with the simultaneous data manager 150 (CM controller 1). The simultaneous data controller 160 is coupled to the internal bus 9. For example, the simultaneous data controller 160 includes a DMAC (direct memory access controller).

The simultaneous data controller 160 instructs the main memory interface circuit 7 and the main memory 8 to write the prefetched data in the cache memory 20 to the main memory 8 in response to the retreat instruction RI from the simultaneous data manager 150. As a result, the prefetched data in the cache memory 20 is retreated to the main memory 8. In response to the completion of retreat of data, the simultaneous data controller 160 sends a retreat completion notification RC to the simultaneous data manager 150 directly or via the internal bus 9. As a result, the simultaneous data manager 150 detects the completion of retreat of data.

For example, the retreat completion notification RC includes information on an area in the main memory 8 in which the retreated data is stored.

The simultaneous data controller 160 may be provided in the CM controller 1 or in the prefetch controller 10a.

### (b) Example of Operation

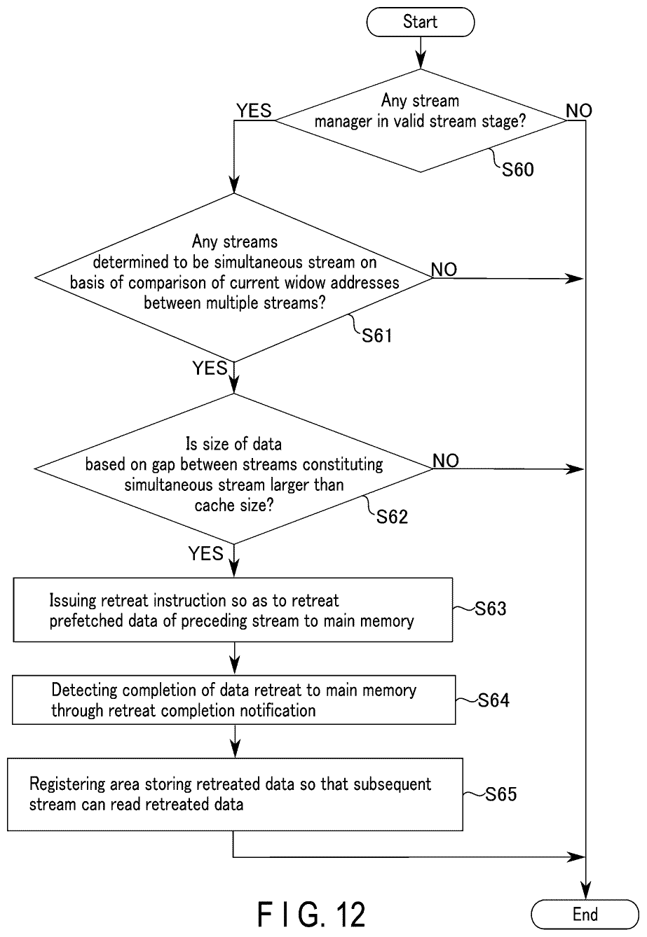

An example of operations (control method) of the CM controller 1 according to the present embodiment will be described with reference to FIG. 12.

FIG. 12 is a flowchart for illustrating the control of retreat of data from the cache memory 20 in the data transfer through the simultaneous stream SS in the CM controller 1 according to the present embodiment.

### S60

As shown in FIG. 12, the CM controller 1 checks whether or not the stream manager 100 in the valid stream stage STG2 is present.

### S60-NO

In a case of no stream manager 100 in the valid stream stage STG2, the CM controller 1 terminates various types of processing relating to the retreat of data in the cache memory 20.

### S60-YES, S61

In a case where the stream manager 100 in the valid stream stage STG2 is present, the CM controller 1 checks whether or not there is a stream STR that is determined to be the simultaneous stream SS on the basis of a comparison between addresses corresponding to current windows (read access) Win2 of the respective streams STR.

For example, the CM controller 1 calculates, using the stream address comparison unit 152, the presence or absence of a pair of addresses of a plurality of current windows Win2 each having an address difference that falls within the range of a simultaneous stream detection maximum size. The simultaneous stream detection maximum size is a set value stored in the detection maximum size storage unit 154.

### S61-NO

In a case of no stream STR that is determined to be the simultaneous stream SS, the CM controller 1 determines that the transfer of the simultaneous stream SS has not occurred. The CM controller 1 terminates various types of processing relating to the retreat of data in the cache memory 20.

### S61-YES, Y62

In a case where there is a stream STR that is determined to be the simultaneous stream SS, the CM controller 1 determines whether or not the size of data based on the gap GA between the plurality of streams STR that constitute the simultaneous stream SS is larger than the cache size (the storage capacity of the cache memory 20). Specifically, the CM controller 1 determines whether or not the size of data calculated based on the difference between addresses corresponding to the current windows Win2 of the respective streams STRa and STRb each determined to be the simultaneous stream SS is larger than the cache size. This calculated data size may be compared with a threshold value that is smaller than the cache size.

### S62-NO

In a case where the data size based on the gap GA between the plurality of streams STR that constitute the simultaneous stream SS is equal to or smaller than the cache size, the CM controller 1 terminates various types of processing relating to the retreat of data in the cache memory 20.

### S62-YES, S63

In a case where the size of data based on the gap GA between the plurality of streams STR constituting the simultaneous stream set SS is larger than the cache size, the CM controller 1 issues the retreat instruction RI to retreat the prefetched data corresponding to the earlier stream STRa of the simultaneous stream SS from the cache memory 20 to the main memory 8.

For example, the simultaneous data manager 150 transmits the retreat instruction RI to the simultaneous data controller 160. Based on the retreat instruction RI, the simultaneous data controller 160 writes the corresponding prefetched data in the cache memory 20 to the main memory 8. As a result, the prefetched data of the preceding stream STRa is retreated in the main memory 8.

The simultaneous data controller 160 issues the retreat completion notification RC upon the completion of the retreat of data to the main memory 8. The simultaneous data controller 160 transmits the issued retreat completion notification RC to the simultaneous data manager 150. The retreat completion notification RC includes information regarding an address of the main memory 8 to which the retreated data has been written.

### S64

The CM controller 1 detects the completion of the retreat of data to the main memory 8 by the retreat completion notification RC. For example, the simultaneous data manager 150 receives the retreat completion notification RC. As a result, the simultaneous data manager 150 detects the completion of retreat of data.

### S65

The CM controller 1 registers an address of an area in the main memory 8 in which retreated data is stored such that the retreated data can be read out in the subsequent stream STRb of the simultaneous stream SS. The retreated data corresponds to prefetched data corresponding to the subsequent stream STRb.

For example, the simultaneous data manager 150 stores, in the retreat area tracking unit 151 an address of an area storing therein the retreated data, on the basis of information included in the retreat completion notification RC.

Through the processing flow described above, the CM controller 1 completes the control of the retreat of data from the cache memory 20.

### (c) Summary

The CM controller 1 according to the present embodiment calculates a data size of data to be prefetched from the simultaneous stream SS, on the basis of the difference between an address corresponding to the current window Win2 of the earlier stream STRa and an address corresponding to the current window Win2 of the later stream STRb at the time of transfer of data through the simultaneous stream SS. In a case where the data size of data prefetched from the simultaneous stream SS exceeds the cache size of the cache memory 20, the CM controller 1 retreats the prefetched data in the cache memory 20 to the main memory 8.

This enables the CM controller 1 according to the present embodiment to avoid a time penalty that occurs in a case where data that is the same as the data prefetched in the earlier stream STRa is re-read or re-prefetched in the later stream STRb.

Therefore, the CM controller 1 according to the present embodiment can improve the performance of data transfer.

### (3) Third Embodiment

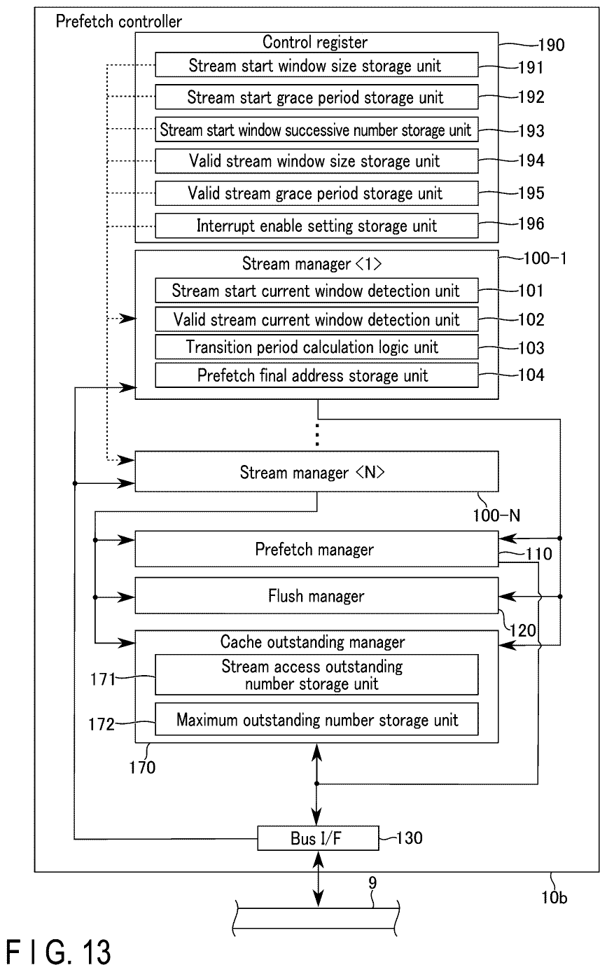

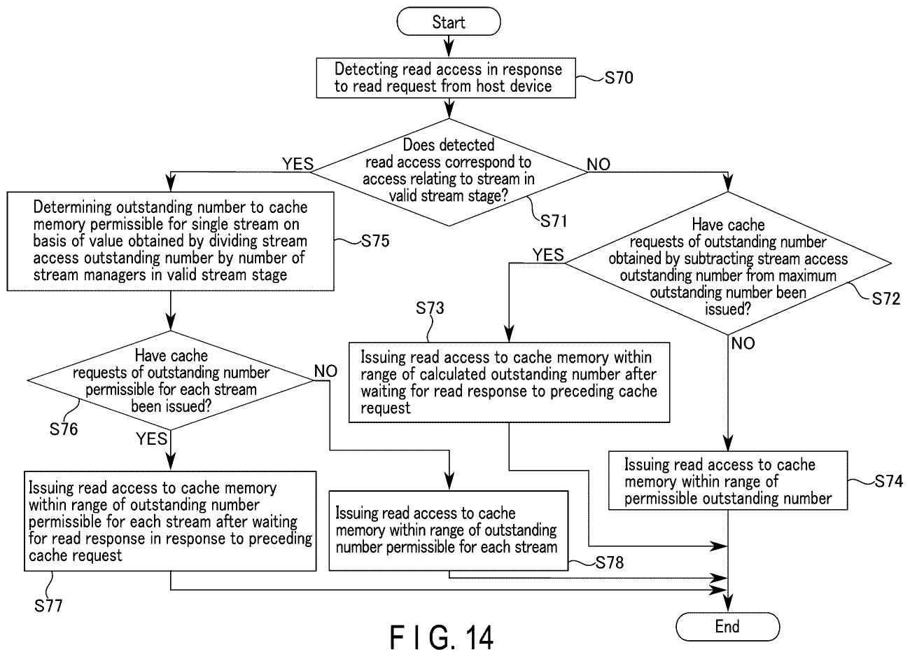

A memory controller and a control method of a memory controller according to a third embodiment will be described with reference to FIG. 13 and FIG. 14.

### (a) Example of Configuration

An example of a configuration of a CM controller 1 according to the present embodiment will be described with reference to FIG. 13.

FIG. 13 is a block diagram showing a functional configuration of the CM controller 1 according to the present embodiment.

As shown in FIG. 13, in the CM controller 1 according to the present embodiment, a prefetch controller 10b further includes a cache outstanding manager 170 as compared to the prefetch controller 10 shown in FIG. 5.

The cache outstanding manager 170 performs dynamic outstanding control of the cache memory 20.

The cache outstanding manager 170 includes a stream access outstanding number storage unit 171 and a maximum outstanding number storage unit 172.

The stream access outstanding number storage unit 171 stores the total number of outstanding numbers of one or more streams STR in the valid stream stage STG2. The outstanding number indicates the number of requests that the CM controller 1 can transmit to the cache memory 20 before receiving a response from the cache memory 20 in response to access. Hereinafter, the total number of outstanding numbers of one or more streams STR in the valid stream stage STG2 will be referred to as a “stream access outstanding number”.

The maximum outstanding number storage unit 172 stores a value of the total outstanding number that can be processed by the cache memory 20. Hereinafter, the total outstanding number that can be processed by the cache memory 20 will be referred to as a “maximum outstanding number”.

The CM controller 1 according to the present embodiment controls access (for example, read access) to the cache memory 20, using the cache outstanding manager 170, on the basis of the allowable outstanding number according to the number of transfers of the stream STR that are occurring.

This enables the CM controller 1 according to the present embodiment to perform dynamic control over outstanding (outstanding request) of the cache memory 20.

### (b) Example of Operation

An example of operations (control method) of the CM controller 1 according to the present embodiment will be described with reference to FIG. 14.

FIG. 14 is a flowchart for illustrating dynamic outstanding control of the cache memory 20 in the CM controller 1 according to the present embodiment.

### S70

The CM controller 1 detects read access in response to a read request from the host device HD on the basis of the read request from the host device HD.

### S71

The CM controller 1 checks whether or not the detected read access is access relating to the stream STR in the valid stream stage STG2.

### S71-NO, S72

In a case where the detected read access is not access relating to the stream STR in the valid stream stage STG2, the CM controller 1 checks whether or not cache requests of the outstanding number corresponding to a value obtained by subtracting the stream access outstanding number from the maximum outstanding number have been issued.

### S72-YES, S73

In a case where the outstanding number of cache requests in accordance with the calculated value have already been issued, the CM controller 1 waits for a read response to the preceding cache request, and then issues read access to the cache memory 20 within the range of the calculated outstanding number. The issued read access is read access in response to the read request from the host device HD in S70. The cache memory 20 outputs prefetched data in response to the read access. After issuing the read access, the CM controller 1 terminates the dynamic control of outstanding.

### S72-NO, S74

In a case where the outstanding number of cache requests in accordance with the calculated value have not been issued, the CM controller 1 issues read access to the cache memory 20 within the range of the calculated outstanding number. Herein, the issued read access is also read access in response to the read request from the host device HD in S70. In response to the read access, the cache memory 20 outputs the prefetch data. After issuing the read access, the CM controller 1 terminates the dynamic control of outstanding.

### S71-YES, S75

In a case where the detected read access is access relating to the stream STR in the valid stream stage STG2, the CM controller 1 determines the outstanding number to the cache memory 20 that is permitted for one stream STR, on the basis of a value obtained by dividing the stream access outstanding number by the number of stream managers 100 in the valid stream stage STG2.

### S76

The CM controller 1 checks whether or not the outstanding number of cache requests permitted for each corresponding stream STR have been issued.

### S76-YES, S77

In a case where the permitted outstanding number of cache requests have already been issued, the CM controller 1 waits for a read response with respect to a preceding cache request, and then issues read access to the cache memory 20 within the range of the outstanding number permitted for each stream. Herein, the issued read access is also read access in response to the read request from the host device HD in S70. In response to the read access, the cache memory 20 outputs the prefetch data. After issuing the read access, the CM controller 1 terminates the dynamic control of outstanding.

### S76-NO, S78

In a case where the permitted outstanding number of cache requests have not been issued, the CM controller 1 issues read access to the cache memory 20 within the range of the outstanding number permitted for each stream. Herein, the issued read access is also read access in response to the read request from the host device HD in S70. In response to the read access, the cache memory 20 outputs the prefetch data. After issuing the read access, the CM controller 1 terminates the dynamic control of outstanding.

Through the processing described above, the CM controller 1 completes the dynamic control of outstanding in the cache memory 20

### (c) Summary

The CM controller 1 according to the present embodiment adjusts the outstanding number for the cache memory 20 for each stream STR in accordance with the number of transfers of streams STR that are occurring. This enables the CM controller 1 according to the present embodiment to suppress stagnation in reading of data from the cache memory 20 in accordance with dependencies between the plurality of streams STR in the cache memory 20.

Therefore, the CM controller 1 according to the present embodiment can improve the performance of data transfer.

### (4) Others

In the multiple embodiments described above, an example is shown in each in which the CM controller 1 according to each embodiment is provided within the memory system MS including the non-volatile memory 300.

However, the CM controller 1 according to the present embodiment may be applicable to a system or a device other than the memory system MS, as long as the system is provided with a cache memory.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory controller comprising:
a controller circuit configured to detect one or more streams including a plurality of windows of data to be transferred to a host device, the controller circuit being configured to control prefetching of the data; and
a cache memory configured to store prefetched data,
wherein the controller circuit is configured to detect the streams on a basis of a data size of each of one or more first windows among the plurality of windows and a successive number of the first windows in a first period.

2. The memory controller according to claim 1,
wherein the plurality of windows further includes one or more second windows,
the one or more first windows are included in a first stage of the streams,
the one or more second windows are included in a second stage after the first stage of the streams, and
a data size of each of the second windows is larger than a data size of each of the first windows.

3. The memory controller according to claim 1,
wherein the controller circuit is configured to:
calculate a prefetch amount with respect to data of a single stream on a basis of a number of the streams and a storage capacity of the cache memory; and
issue a request for read access to the cache memory for prefetching of the data of the single stream on a basis of the calculated prefetch amount.

4. The memory controller according to claim 1,
wherein the streams include the one or more first windows included in a first stage and a plurality of second windows included in a second stage after the first stage, and
the controller circuit is configured to detect a degeneration of the streams on a basis of a result of a comparison of a transition period between successive second windows among the plurality of second windows with a second period different from the first period.

5. The memory controller according to claim 4,
wherein in a case where the degeneration of the streams is detected, the memory controller is configured to issue a request for erasing, from the cache memory, data corresponding to the degenerated streams stored in the cache memory.

6. The memory controller according to claim 1,
wherein the one or more streams include a first stream and a second stream, and
in a case where the data commonly includes a plurality of windows of the first stream and a plurality of windows of the second stream, the controller circuit is configured to:
calculate a size of data to be prefetched of the first and second streams on a basis of a difference between an address corresponding to a current window of the first stream and an address corresponding to a current window of the second stream; and
in a case where the size of the data to be prefetched exceeds a storage capacity of the cache memory, issue a request for retreating data in the cache memory from the cache memory to a main memory.

7. The memory controller according to claim 1, further comprising a data controller configured to control data retreat from the cache memory to a main memory,
wherein the controller circuit is configured to:
transmit, to the data controller, a retreat instruction of the data; and
receive, from the data controller, a notification of a completion of the data retreat to the main memory.

8. The memory controller according to claim 1,
wherein the controller circuit is configured to:
calculate an outstanding number for each stream on a basis of a number of the detected streams and an outstanding number processable by the cache memory; and
control an outstanding number of read access to the cache memory in each of the streams in accordance with the calculated outstanding number.

9. A memory system comprising:
the memory controller according to claim 1; and
a non-volatile memory configured to store the data to be transferred to the host device.

10. The memory system according to claim 9, further comprising an interface circuit coupled to the memory controller via a bus and configured to communicate with the host device on a basis of a Compute Express Link (CXL) specification.

11. A control method of a memory controller including a cache memory configured to store prefetched data, the method comprising:
processing read access in response to a request from a host device;
detecting one or more streams including a plurality of windows of data to be transferred to the host device in response to the read access on a basis of a data size of each of one or more first windows among the plurality of windows and a successive number of the first windows; and
controlling prefetching of the data of the detected one or more streams using the cache memory.

12. The method according to claim 11,
wherein the plurality of windows further includes one or more second windows,
the one or more first windows are included in a first stage of the streams,
the one or more second windows are included in a second stage after the first stage of the streams, and
a data size of each of the second windows is larger than a data size of each of the first windows.

13. The method according to claim 11, further comprising:
calculating a prefetch amount with respect to data of a single stream on a basis of a number of the streams and a storage capacity of the cache memory; and
issuing a request for read access to the cache memory for prefetching of the data of the single stream on a basis of the calculated prefetch amount.

14. The method according to claim 11,
wherein the streams include the one or more first windows included in a first stage and a plurality of second windows included in a second stage after the first stage, and
the method further comprises detecting a degeneration of the streams on a basis of a result of a comparison between a transition period between successive second windows in the plurality of second windows and a second period different from the first period.

15. The method according to claim 14, further comprising, in a case where the degeneration of the streams is detected, issuing a request for erasing, from the cache memory, data corresponding to the degenerated streams stored in the cache memory.

16. The method according to claim 11, further comprising:
in a case where a first stream and a second stream are detected and the data commonly includes a plurality of windows of the first stream and a plurality of windows of the second stream, calculating a size of data to be prefetched of the first and second streams on a basis of a difference between an address corresponding to a current window of the first stream and an address corresponding to a current window of the second stream; and
in a case where the size of the data to be prefetched exceeds a storage capacity of the cache memory, issuing a request for retreating data in the cache memory from the cache memory to a main memory.

17. The method according to claim 16, further comprising:
transmitting a retreat instruction of the data, to a data controller configured to control data retreat from the cache memory to the main memory; and
receiving, from the data controller, a notification of a completion of the data retreat to the main memory.

18. The method according to claim 11, further comprising:
calculating an outstanding number for each stream on a basis of a number of the detected streams and an outstanding number processable by the cache memory; and
controlling an outstanding number of read access to the cache memory in each of the streams in accordance with the calculated outstanding number.

19. The method according to claim 11,
wherein communication between the non-volatile memory and the host device is based on a Compute Express Link (CXL) specification.
